(19) United States
(12) Patent Application Publication
(10) Pub. No.: US 2011/0035655 A1
(43) Pub. Date: Feb. 10, 2011

(54) Generating Forms Using One or More Transformation Rules

(75) Inventor: Miguel Rolando Heineken, Rauenberg (DE)

Correspondence Address: FISH & RICHARDSON, P.C., PO BOX 1022, MINNEAPOLIS, MN, 55440-1022, US

(73) Assignee: SAP AG, Walldorf (DE)

(21) Appl. No.: 12/535,429

(22) Filed: Aug. 4, 2009

(51) Int. Cl. G06F 17/00

(52) U.S. Cl. 715/223

(57) ABSTRACT

A computer-implemented method, computer program product, and system for generating a form may identify at least one form definition defining a form, where the form includes a form element having at least one value set by the form definition, apply at least one rule to the form definition, where the rule is associated with the form element; and adjust, based on the rule, the value of the form element in the form definition.

### TECHNICAL BACKGROUND

This disclosure relates to generating forms and, more particularly, to generating forms with one or more form elements adjusted according to one or more transformation rules.

### BACKGROUND

Form development may be accomplished by a variety of methods and techniques. Form elements such as text fields, logos, lines, and frames may be created manually, for example, by a form designer. For instance, a form design tool, such as Adobe Lifecycle Designer, may be used to manually create form elements and forms. Typically, forms may be similar in the sense that they share a common structure of company logo, letterhead, recipient address field, and other elements. In order to change or adjust the characteristics of the form elements in a particular form, they often have to be created by the form developer manually from scratch for each new form. This may lead to inconsistencies (e.g., different naming conventions, slightly different positions of form elements) and to duplicated effort. In other words, each new form, even if based on an similar, existing form, may need to be generated anew. Such manual methods may be especially time consuming and costly depending on the number of forms a form developer may generate or the number of forms a business enterprise may use.

### SUMMARY

In one general embodiment, a computer-implemented method for generating a form performed by one or more processors includes the steps of: identifying at least one form definition defining a form, where the form includes a form element having at least one value set by the form definition; applying at least one rule to the form definition, where the rule is associated with the form element; and adjusting, based on the rule, the value of the form element in the form definition.

In certain specific embodiments, the form may be a first form, adjusting, and based on the rule, the value of the form element in the form definition may include adjusting, based on the rule, the value of the form element in the form definition relative to a value of a corresponding form element in a second form. Further, the step of adjusting, based on the rule, the value of the form element in the form definition may include adjusting at least one of: a location of the form element within the first form relative to a location of the corresponding form element in the second form; a font size of the form element within the first form relative to a font size of the corresponding form element in the second form; and a font color of the form element within the first form relative to a location of the corresponding form element in the second form.

In some embodiments, the method may further include sending the adjusted form definition and form element data associated with the form element to a rendering engine. The method may further include receiving a new form including the form element having the adjusted value and the form element data from the rendering engine; and graphically presenting the new form to a user. In certain aspects, the method may further include generating the rule based on at least one of: a predetermined geographic locale; and a type of the form template. The rule may be stored in an XML document. The form may include at least one of: a purchase order; a delivery note; an invoice; a shipping notification; and a mailing label.

Another general embodiment includes a computer program product for generating a form including computer readable instructions embodied on tangible media that are operable when executed to: identify at least one form definition defining a form, where the form includes a form element having at least one value set by the form definition; apply at least one rule to the form definition, where the rule is associated with the form element; and adjust, based on the rule, the value of the form element in the form definition.

In some specific embodiments, the form may be a first form, and the instructions may be further operable to adjust, based on the rule, the value of the form element in the form definition relative to a value of a corresponding form element in a second form. In addition, the instructions may be further operable to adjust at least one of: a location of the form element within the first form relative to a location of the corresponding form element in the second form; a font size of the form element within the first form relative to a font size of the corresponding form element in the second form; and a font color of the form element within the first form relative to a location of the corresponding form element in the second form. The instructions may be further operable to send the adjusted form definition and form element data associated with the form element to a rendering engine.

In some embodiments, the instructions may be further operable to: receive a new form comprising the form element having the adjusted value and the form element data from the rendering engine; and graphically present the new form to a user. The instructions may be further operable to generate the rule based on at least one of: a predetermined geographic locale; and a type of the form template. In some aspects, the rule may be stored in an XML document. Further, the form may include at least one of: a purchase order; a delivery note; an invoice; a shipping notification; and a mailing label.

In another general embodiment, a system for generating a form includes at least one memory and one or more processors. The memory stores at least one form transformation module; at least one transformation rule; and at least one form definition. The one or more processors are operable to execute the form transformation module, the module operable when executed to: identify at least one form definition defining a form, where the form includes a form element having at least one value set by the form definition; apply the transformation rule to the form definition, where the rule is associated with the form element; and adjust, based on the rule, the value of the form element in the form definition.

In some particular embodiments, the form may include a first form, and the form transformation module may be further operable to adjust, based on the rule, the value of the form element in the form definition relative to a value of a corresponding form element in a second form. In addition, the form transformation module may be further operable to adjust at least one of: a location of the form element within the first form relative to a location of the corresponding form element in the second form; a font size of the form element within the first form relative to a font size of the corresponding form element in the second form; and a font color of the form element within the first form relative to a location of the corresponding form element in the second form. The system may further include a rendering engine stored in the memory, and the form transformation module may be further operable to: send the adjusted form definition and form element data associated with the form element to the rendering engine; receive a new form comprising the form element having the adjusted value and the form element data from the rendering engine; and graphically present the new form to a user.

The form transformation module may also be operable to generate the rule based on at least one of: a predetermined geographic locale; and a type of the form template. In some aspects, the form transformation module may be a first form transformation module and may be operable to: identify a first form structure of the form, where the first form transformation module is associated with a second form structure; and identify, based on the first form structure, a second form transformation module associated with the first form structure. The second form transformation module may be operable when executed by the processor to: identify at least one form definition defining the form, the form including a form element having at least one value set by the form definition; apply the transformation rule to the form definition, where the rule may be associated with the form element; and adjust, based on the rule, the value of the form element in the form definition.

Various embodiments of and including a form transformation module may include one or more of the following features. For example, a form transformation module according to the present disclosure may allow for forms of different variants to be created in a fraction of the time that would be needed relative to manual creation of such forms. Also, the form transformation module may allow for more exact adjustments of one or more form elements relative to a common form template. Additionally, consistency of forms may be substantially increased by following a precise set of transformation rules defining one or more adjustments to the form elements. Further, transformation rules executed by the form transformation module may be easily applied to multiple document structures. The form transformation module may also allow for more efficient implementation of transformation rules through XML format.

These general and specific aspects may be implemented using a device, system or method, or any combinations of devices, systems, or methods. Put differently, while generally described as computer implemented software that generates forms with one or more form elements adjusted according to one or more transformation rules, some or all of the aspects may be computer implemented methods or further included in respective systems or other devices for performing this described functionality. The details of one or more implementations are set forth in the accompanying drawings and the description below. Other features, objects, and advantages will be apparent from the description and drawings, and from the claims.

### DESCRIPTION OF DRAWINGS

FIG. 1 illustrates one embodiment of a system for generating a form using a form transformation module according to the present disclosure;

FIGS. 2A-C illustrate examples of forms generated by and/or transformed by a form transformation module according to the present disclosure;

FIG. 3 illustrates one embodiment of a form transformation interface according to the present disclosure; and

FIG. 4 illustrates an example method for using a form transformation module according to the present disclosure.

### DETAILED DESCRIPTION

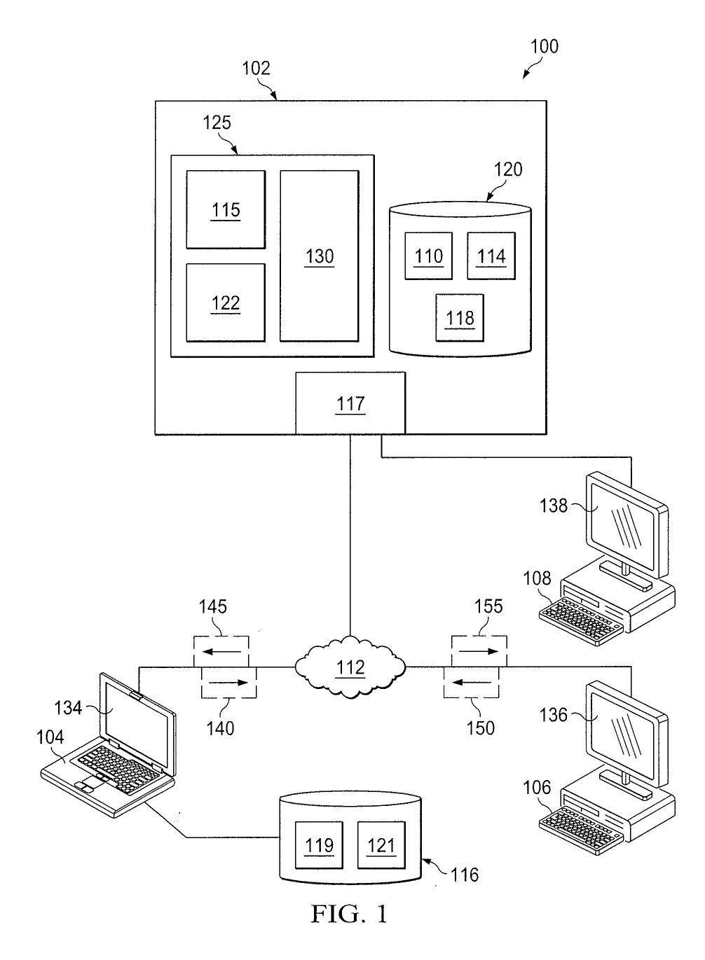

FIG. 1 illustrates an example system 100 for generating one or more forms from a set of form definitions modified by one or more transformation rules. For instance, in some embodiments, one or more forms may be generated from a set of form definitions defining, for example, a purchase order, a delivery note, and invoice, or other type of form. Form definition may, in some aspects, be nonspecific with respect to the country or geographic region to which the defined form may pertain. As one example, a particular country, such as France, may have particular postal requirements for delivery notice forms. Such requirements may include a particular location of the addressee on the delivery notice form. In contrast, another country, such as the United Kingdom, may have different requirements regarding the location of the addressee on a delivery notice form. A new form specific to the United Kingdom may be generated based upon the French delivery notice form and its associated form definitions. Thus, a new delivery notice form for the United Kingdom may be more efficiently be generated. In some embodiments, a form transformation module of the system 100 may be utilized to generate new forms and/or transform existing forms into new forms.

Generally, system 100 uses a form transformation module 130 to allow developers to generate new forms using existing form definitions more quickly and efficiently. This form transformation module 130 may, among other things, be a hosted software application, which achieves a rich, internet application a developer or other user by minimizing scripts, business logic, and processing. Form transformation module 130 may additionally provide for increased bandwidth availability, thereby increasing data transmission speed between client 104 and server 102, as well as allowing for increased implementations by small customers. Further, form transformation module 130 may be updated with software code fixes, as appropriate, without requiring any patching, upgrading, or other updating on client 104.

In some embodiments of system 100, a local developer 108 may utilize or execute the form transformation module 130 hosted on the server 102. As illustrated in FIG. 1, the local developer 108 may be communicably coupled to the server 102 through an interface 117. In other words, the local developer 108 may be at the same location as the server 102, or alternatively, reside at a separate location but be in communication with the server 102. The local developer 108 may include a graphical user interface (GUI) 138 through which one or more interfaces with the form transformation module 130 may be presented to the local developer 108.

In some embodiments of the system 100, a remote developer 106 may be communicably coupled to the server 102 through a network 112. As with the local developer 108, the remote developer 106 may utilize or execute the form transformation module 130 hosted on the server 102. The remote developer 106 may include GUI 136, through which one or more interfaces with the form transformation module 130 may be presented to the remote developer 106. As described below in more detail, a form request 150 may be transmitted between the remote developer 106 and the form transformation module 130 via the server 102. Further, a new form 155 may also be communicated between the form transformation module 130 on the server 102 and the remote developer 106. In short, one or more developers, such as the local developer 108 and the remote developer 106, may execute and/or utilize the form transformation module 130 hosted on the server 102. Even further, in some embodiments, the client 104 may utilize and/or execute the form transformation module 130 hosted on server 102.

Referring to illustrated FIG. 1, the form transformation module 130 resides on server 102. The server 102 may be a server controlled by the developer of the system 100 (e.g., the local developer 108), on a server controlled by the user of the system 100, or alternatively, on a server at a third party providing hosting services. Accordingly, system 100 may implement a suite of tightly integrated products that offer business such as client 104 the ability to implement custom software applications through drag-and-drop or other modeling techniques, without the necessity of customized code.

System 100 is typically a distributed client/server system that spans one or more networks such as network 112. As described above, rather than being delivered as packaged software, system 100 may represent a hosted solution, often for an enterprise or other small business that may scale cost-effectively and help drive faster adoption. In this case, portions of the hosted solution may be developed by a first entity, while other components are developed by a second entity. These entities may participate in any suitable form of revenue or cost sharing as appropriate. Moreover, the processes or activities of the hosted solution may be distributed amongst these entities and their respective components. Accordingly, it may enable third-party service providers to offer their services at the business object level through a seamless user-experience. In another example, system 100 may implement a component-based architecture and strong platform helping engage service providers to develop targeted solutions for sub-verticals or others types of markets. This implementation may emphasize features that helps benefit businesses that sell via online stores, thereby leveraging strategic relationships to bring the product to market. In such embodiments, data may be communicated or stored in an encrypted format. This encrypted communication may be between the client and the host or amongst various components of the host. Further, system 100 may store data (user, transaction, service provider, and such) at a relatively central location (over WAN), while concurrently maintaining local data at the user's site for redundancy and to allow processing during downtime. But system 100 may be in a dedicated enterprise environment—across a local area network (over LAN) or subnet—or any other suitable environment without departing from the scope of this disclosure.

Turning to the illustrated embodiment, system 100 includes or is communicably coupled with server 102, one or more clients 104, one or more remote developers 106, and one or more local developers 108, at least some of which communicate across network 112. Server 102 comprises an electronic computing device operable to receive, transmit, process, and store data associated with system 100. Each computer is generally intended to encompass any suitable processing device. For example, although FIG. 1 illustrates one server 102 that may be used with the disclosure, system 100 can be implemented using computers other than servers, as well as a server pool. Indeed, server 102 may be any computer or processing device such as, for example, a blade server, general-purpose personal computer (PC), Macintosh, workstation, Unix-based computer, or any other suitable device. In other words, the present disclosure contemplates computers other than general purpose computers as well as computers without conventional operating systems. Server 102 may be adapted to execute an operating system including Linux, UNIX, Windows Server, or any other suitable operating system. According to one embodiment, server 102 may also include or be communicably coupled with a web server and/or a mail server.

Illustrated server 102 includes local memory 120. Memory 120 may include any memory or database module and may take the form of volatile or non-volatile memory including, without limitation, magnetic media, optical media, random access memory (RAM), read-only memory (ROM), removable media, or any other suitable local or remote memory component. Illustrated memory 120 includes one or more form definitions 114, one or more forms 118, and one or more transformation rules 110. But memory 120 may also include any other appropriate data such as VPN applications or services, firewall policies, a security or access log, print or other reporting files, HTML files or templates, data classes or object interfaces, child software applications or sub-systems, and others.

Form definitions 114 may be stored in memory 120 as illustrated in FIG. 1. At a high level, form definitions 114 may define a type of form (e.g., a purchase order, invoice, shipping notification) and particular information that will be rendered into the form (i.e., one or more form elements). The form definitions 114 may also be adjustable or designable by, for example, the local developer 108, the remote developer 106, or even the client 104. As one specific example, a form definition 104 may specify that a particular form, such as a purchase order, may include shipping information, payment information, and product and/or service information. The form definition 114, however, may not specify the particular data that is applicable to such form elements. In short, the form definition 114 may specify the type of information required or desired in a particular form but may not specify information that is customizable or different from form-to-form (e.g., name of the purchaser, address of the shipper).

Forms 118 may also be stored in memory 120 on server 102. The forms 118, in some embodiments, may be generated from one or more form definitions 114 and specific data (e.g., data provided by the client 104 regarding, for example, a company logo, company address, and other specific data) through execution of the form transformation module 130. Forms 118 may be purchase orders, invoices, shipping labels, or other appropriate types of document. In some embodiments, the forms 118 may be part of or stored with a separate application, such as business application 122 on server 102. Business application 122, in some embodiments, may also be a hosted application, often for an enterprise or other small business such as client 104. For instance, the business application 122 may provide an end-to-end solution for a business entity, thereby allowing the business entity to more effectively and efficiently operate its business operations, processes, and enterprise. As part of the business application 122, one or more forms 118 may be provided or accessible to the business entity, such as the client 104. Thus, the business application 122 may provide the client 104 with all or most of the forms 118 necessary to run its business.

Memory 120 also includes one or more transformation rules 110. At a high level, the transformation rules 110 may include a set of instructions that specify one or more requirements of a form, such as form 118 stored on memory 120. In some embodiments, the transformation rules 110 specify, among other things, a location, font size, font type, language, font color, or position of one or more form elements included in a form. The form elements are typically one or more pieces of discrete data, such as a shipping address, addressee, sender's address, company identification, company logo, and/or one or more details regarding a product or service to be delivered. In some embodiments, the transformation rules 110 specify criteria of one or more form elements relative to an existing form template, such as a form definition 114 stored in the memory 120.

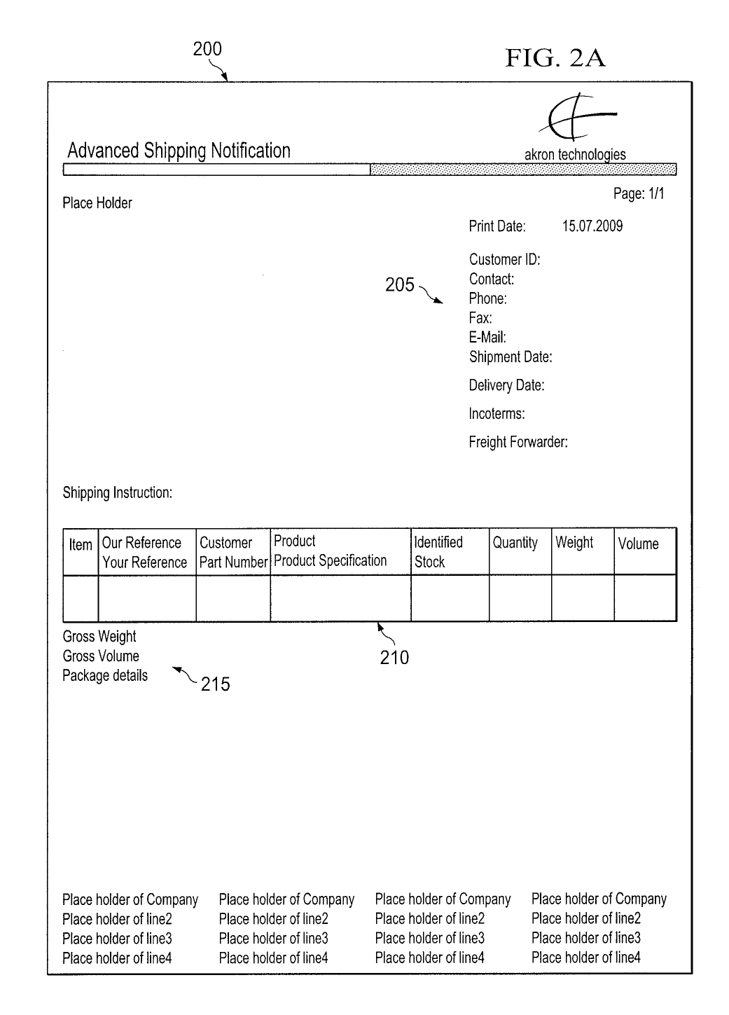

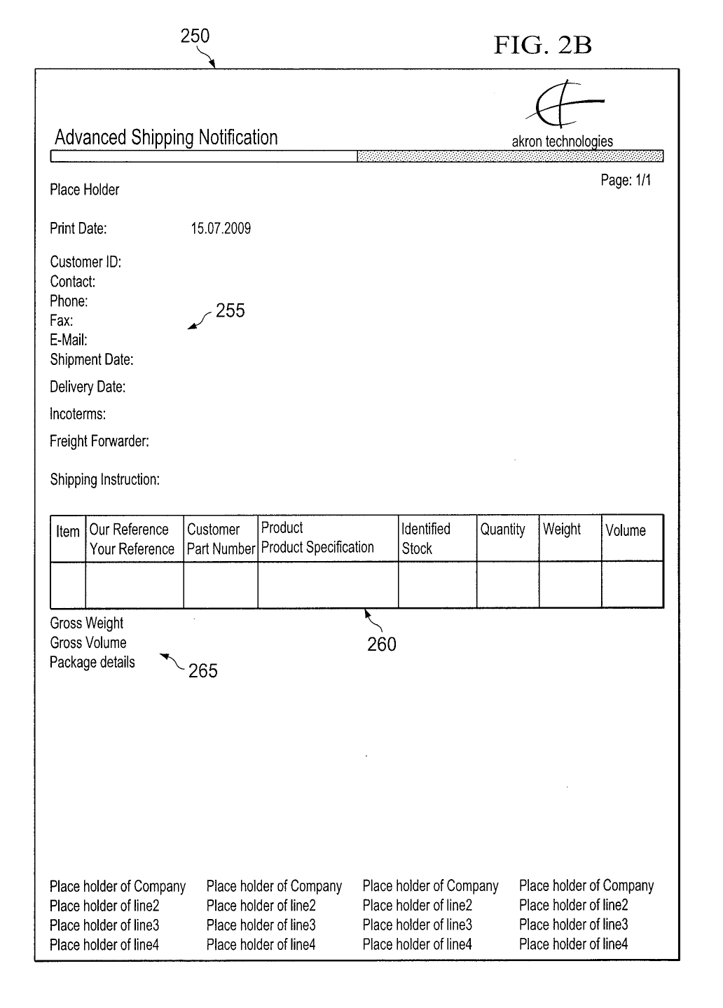

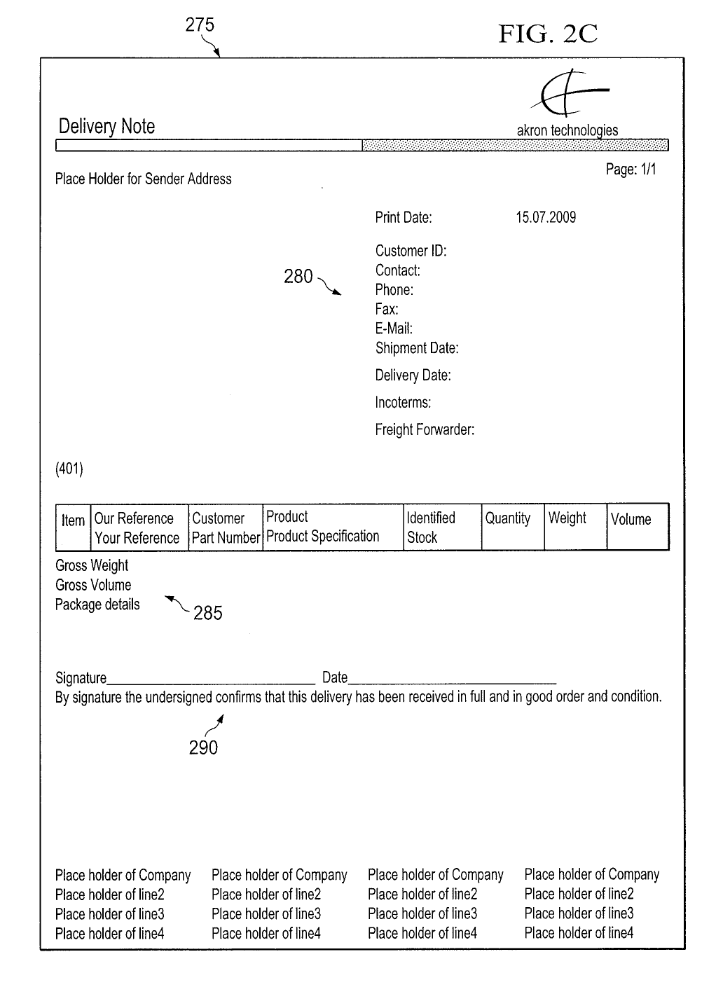

Turning to FIGS. 2A-C, several example forms are illustrated. With reference to FIG. 2A in particular, a form 200 is illustrated, including form elements 205, 210, and 215. Form element 205, for example, represents contact information for a purchaser of a particular product or service. As illustrated in FIG. 2A, form element 205 is aligned along the right side of the form 200. Additional form elements 210 and 215 are also included on the form 200 and represent certain shipping information. Form elements, however, may represent any particular type of data as appropriate on a particular form. Turning now to FIG. 2B to be, a form 250 is illustrated, including form elements 255, 260, and 265. In some embodiments, the form 250 may be generated according to form definitions used to generate form 200 and one or more transformation rules by a form transformation module 130. As illustrated in form 250, the form element 255 also represents shipping information. Form element 255, however, is illustrated as located along the left side of the form 250. Thus, at a high level, the form transformation module 130 may be utilized to adjust the location of the form element 205 to the location of the form element 255 through one or more transformation rules 110, which may specify the exact movement distance of the form element. For example, in some embodiments, the transformation rules 110 may include software or code that specifies the exact distance (e.g., 5 inches to the left) that the form element 205 should be moved.

Turning to FIG. 2C, another example of a form 275 is illustrated. As shown, the form template 275 includes form elements to 280, 285, and 290. Form 275, as one example, is illustrated as a delivery note form. In some embodiments, the form 275 may be generic as to a country or geographic region to which the delivery note is applicable. In other embodiments, however, that the form 275 may be specific to a particular country. For instance, form 275 may represent an appropriate delivery note according to the postal (or other governmental agency) requirements in United States. As such, the particular locations, font size, font color, font type, and language illustrated in form 275 may meet such requirements in the United States.

Returning to FIG. 1, the transformation rules 110 are typically software or code that may be applied the form definition 114 by the form transformation module 130 in order to generate one or more forms 114. In some embodiments, for example, the transformation rules 110 may be contained in one or more eXtensible Markup Language (XML) files. Alternatively, the transformation rules 110 may he contained in any appropriate code, language, or protocol (e.g., Virtual Storage Access Method (VSAM) files, flat files, Btrieve files, comma-separated-value (CSV) files, internal variables, or one or more libraries) that is executable by the server 102. For example, one embodiment of a portion of the transformation rules 110 in XML format may follow the example format:

```
- <form name=“FormPurchaseOrderConfirmation”>
  <!-- Wrong Name in Form, request change to SC -->
  <header>
    <C_OM_FMT_name>Sales Order</C_OM_FMT_name>
    <C_OM_FMT_tpcode>C0001</C_OM_FMT_tpcode>
    <INT_VAR_BC_SET_Name>BC_A1S_SC_SLO_PF_SO_VAR</INT_VAR_BC_SET_Name>
  </header>
- <body>
  - <transformation target_country=“US”>
    - <rules>
        <call_function name=“SetToLetter” pageName=“mstPage1” />
        <call_function name=“SetToLetter” pageName=“mstPage2” />
        <set_element_property element_path=“frmAddressBlock”
      property=“font” attribute=“size” value=“8pt” maxDepth=“unbounded”
      createProperty=“no” />
        <create_element type=“subform” name=“frmSenderAdd_Page”
      parent_path=“bdyMain” reference_path=“bdyMain\frmPage” />
        <set_element_property element_path=“frmSenderAdd_Page”
      property=“this” attribute=“h” value=“10.2mm” />
        <position_element element_path=“bdyMain\frmPage”
      parent_path=“bdyMain\frmSenderAdd_Page” />
        <position_element
      element_path=“bdyMain\frmAddInfoBlock\frmAddressBlock\lbl_A1SFC_SenderAddress”
      parent_path=“bdyMain\frmSenderAdd_Page” />
        <set_element_property
      element_path=“bdyMain\frmSenderAdd_Page\lbl_A1SFC_SenderAddress”
      property=“margin” attribute=“leftInset” value=“0mm” />
        <set_element_property element_path=“bdyMain\frmSenderAdd_Page”
      property=“margin” attribute=“topInset” value=“4mm” />
        <set_element_property element_path=“lblSpace” property=“this”
      attribute=“h” value=“13mm” />
        <set_element_property
      element_path=“bdyMain\frmSenderAdd_Page\frmPage”
      property=“margin” attribute=“topInset” value=“0mm” />
        <call_function name=“AdaptInfoBlockToUS”
      subform=“bdyMain\frmAddInfoBlock\frmInfoBlock”
      subformLeftInset=“34.5mm” />
  </rules>
```

Illustrated server 102 also includes processor 125. Processor 125 executes instructions and manipulates data to perform the operations of server 102. Processor 125 is, for example, a central processing unit (CPU), a blade, an application specific integrated circuit (ASIC), or a field-programmable gate array (FPGA). Although FIG. 1 illustrates a single processor 125 in server 102, multiple processors 125 may be used according to particular needs and reference to processor 125 is meant to include multiple processors 125 where applicable. In the illustrated embodiment, processor 125 executes form transformation module 130, a rendering engine 115, and/or business application 122.

At a high level, the form transformation module 130 is operable to generate one or more forms 114 based on one or more form definitions 114 and according to one or more of the transformation rules 110. More specifically, form transformation module 130 is any application, program, module, process, or other software that receives or identifies the form definitions 114 and the transformation rules 110, and generates adjusted form definition according to the transformed rules 110. Regardless of the particular implementation, “software” may include software, firmware, wired or programmed hardware, or any combination thereof as appropriate. Indeed, form transformation module 130 may be written or described in any appropriate computer language including C, C++, Java, Visual Basic, assembler, Perl, any suitable version of 4GL, as well as others. For example, form transformation module 130 may be a composite application, portions of which may be implemented as Enterprise Java Beans (EJBs) or the design-time components may have the ability to generate run-time implementations into different platforms, such as J2EE (Java 2 Platform, Enterprise Edition), ABAP (Advanced Business Application Programming) objects, or Microsoft's .NET. It will be understood that while form transformation module 130 is illustrated in FIG. 1 as a single module, form transformation module 130 may include numerous other sub-modules or may instead be a single multi-tasked module that implements the various features and functionality through various objects, methods, or other processes. Further, while illustrated as internal to server 102, one or more processes associated with form transformation module 130 may be stored, referenced, or executed remotely. For example, a portion of form transformation module 130 may be a web service that is remotely called, while another portion of form transformation module 130 may be an interface object bundled for processing at remote client 104. Moreover, form transformation module 130 may be a child or sub-module of another software module or enterprise application (not illustrated) without departing from the scope of this disclosure.

Processor 125 may also execute rendering engine 115 on the server 102. Rendering engine 115, at a high-level, may receive the form definitions as modified according to the transformation rules 110 by the form transformation module 130 and specific form element data and render (e.g., generate) a new form, such as form 118. In some embodiments, the rendering engine 115 may be specific to a particular document format or form format. For instance, various form or document formats include Adobe PDF and Microsoft Infopad. In some embodiments, the form transformation module 130 may be specific to a particular format. Thus, server 102 may include multiple form transformation modules 130 with each module 130 corresponding to a specific format. In any event, the form transformation module 130 may be utilized with any document format that utilizes form definitions and data to generate a form, regardless of the specific format.

Server 102 may also include interface 117 for communicating with other computer systems, such as clients 104 or remote developers 106, over network 112 in a client-server or other distributed environment, as well as the local developer 108. In certain embodiments, server 102 receives data from internal or external senders through interface 117 for storage in memory 120 and/or processing by processor 125. Generally, interface 117 comprises logic encoded in software and/or hardware in a suitable combination and operable to communicate with network 112. More specifically, interface 117 may comprise software supporting one or more communications protocols associated with communications network 112 or hardware operable to communicate physical signals.

Network 112 facilitates wireless or wireline communication between computer server 102 and any other local or remote computer, such as clients 104. Network 112 may be all or a portion of an enterprise or secured network. In another example, network 112 may be a VPN merely between server 102 and client 104 across wireline or wireless link. Such an example wireless link may be via 802.11a, 802.11b, 802.11g, 802.11n, 802.20, WiMax, and many others. While illustrated as a single or continuous network, network 112 may be logically divided into various sub-nets or virtual networks without departing from the scope of this disclosure, so long as at least portion of network 112 may facilitate communications between server 102 and at least one client 104 and/or one remote developer 106. Network 112 may communicate, for example, Internet Protocol (IP) packets, Frame Relay frames, Asynchronous Transfer Mode (ATM) cells, voice, video, data, and other suitable information between network addresses. Network 112 may include one or more local area networks (LANs), radio access networks (RANs), metropolitan area networks (MANs), wide area networks (WANs), all or a portion of the global computer network known as the Internet, and/or any other communication system or systems at one or more locations. In certain embodiments, network 112 may be a secure network associated with the enterprise and certain remote clients 104 or remote developers 106. Further, although illustrated in FIG. 1 as directly connected to the interface 117, the local developer 108 may also be communicably coupled to the server 102 through the network 112.

Client 104 is any computing device operable to connect or communicate with server 102 or network 112 using any communication link. At a high level, each client 104 includes or executes at least GUI 134 and comprises an electronic computing device operable to receive, transmit, process, and store any appropriate data associated with system 100. While illustrated separately, client 104 typically includes local memory 116 or may be coupled with some relatively remote or distributed memory that may be quickly accessed. It will be understood that there may be any number of clients 104 communicably coupled to server 102. Further, “client,” “business,” and “user” may be used interchangeably as appropriate without departing from the scope of this disclosure. Moreover, for ease of illustration, each client 104 is described in terms of being used by one user. But this disclosure contemplates that many users may use one computer or that one user may use multiple computers. In certain situations, users may include one or more developers.

As used in this disclosure, client 104 is any person, department, organization, small business, enterprise, or any other entity that may use or request others to use system 100, namely form transformation module 130. For simplicity, client 104 may encompass a personal computer, touch screen terminal, workstation, network computer, kiosk, wireless data port, smart phone, personal data assistant (PDA), one or more processors within these or other devices, or any other suitable processing device used by or for the benefit of client 104. For example, client 104 may be a PDA operable to wirelessly connect with an external or unsecured network. In another example, client 104 may comprise a laptop that includes an input device, such as a keypad, touch screen, mouse, or other device that can accept information, and an output device that conveys information associated with the operation of server 102 or clients 104, including digital data, visual information, or GUI 134. Both the input device and output device may include fixed or removable storage media such as a magnetic computer disk, CD-ROM, or other suitable media to both receive input from and provide output to users of clients 104 through the display, namely, the client portion of GUI or application interface 134.

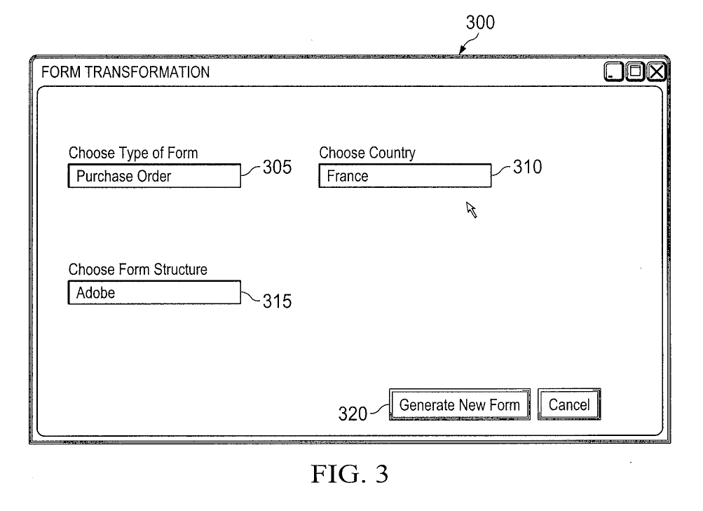

Local developer 108 and remote developer 106 include GUI 138 and GUI 136, respectively. Generally, the illustrated GUIs each represent a graphical user interface operable to allow the client 104, local developer 108 and/or the remote developer 106 to interface with at least a portion of system 100 for any suitable purpose, such as viewing application or other transaction data. Generally, the illustrated GUIs provide the particular user with an efficient and user-friendly presentation of data provided by or communicated within system 100. As shown in FIG. 3, each illustrated GUI may comprise a plurality of customizable frames or views having interactive fields, pull-down lists, and buttons operated by the user.

GUI 134 may also present a plurality of portals or dashboards. For example, GUI 134 may display a portal that allows users to view, create, and manage historical and real-time reports including role-based reporting and such. Generally, historical reports provide critical information on what has happened including static or canned reports that require no input from the user and dynamic reports that quickly gather run-time information to generate the report. Of course, reports may be in any appropriate output format including PDF, HTML, and printable text. Real-time dashboards often provide table and graph information on the current state of the data, which may be supplemented by business objects. GUI 134 is often configurable, supporting a combination of tables and graphs (bar, line, pie, status dials, etc.), and is able to build real-time dashboards. It should be understood that the term graphical user interface may be used in the singular or in the plural to describe one or more graphical user interfaces and each of the displays of a particular graphical user interface. Indeed, reference to GUI 134 (or any illustrated GUI) may indicate a reference to the front-end or a component of form transformation module 130 and/or the business application 122, as well as the particular interface accessible via client 104 (or local developer 108 or remote developer 106), as appropriate, without departing from the scope of this disclosure. Therefore, the illustrated GUIs contemplate any graphical user interface, such as a generic web browser or touch screen that processes information in system 100 and efficiently presents the results to the user. Server 102 can accept data from client 104, local developer 108, and/or remote developer 106 via the web browser (e.g., Microsoft Internet Explorer or Netscape Navigator) and return the appropriate HTML or XML responses to the browser using network 112.

In some embodiments, the form transformation module 130 as a hosted application may be executed by, for instance, a developer (or other user) at client 104. For example, client 104 may determine that one or more forms 118 included or referenced by hosted business application 122 require adjustment of one or more form elements. Client 104 may send a request 140, including one or more remote form definitions 119 and one or more remote transformation rules 121 stored in memory 116, to the server 102 via the network 112. Upon execution of the form transformation module 130 to incorporate the remote transformation rules 121 into the remote form definitions 119, the client 104 may call or execute the rendering engine 115 to generate a new form. The new form may subsequently be delivered to client 104 as form 145 via the network 112. Alternatively, client 104 may execute or call the form transformation module 130 remotely but specify or identify one or more particular form definitions 114 and transformation rules 110 hosted on server 110 in order to generate form 145.

In similar fashion, the remote developer 106 may send a request 150, including one or more remote form definitions and one or more remote stored in a memory or database communicably coupled to the remote developer 106. Such form definitions may be form definitions 119, form definitions 114, or other form definitions. Further, such transformation rules may be remote transformation rules 121, hosted transformation rules 110, or other transformation rules. Upon execution of the form transformation module 130 to incorporate the identified transformation rules into the identified form definitions, the remote developer 106 (or form transformation module 130) may call or execute the rendering engine 115 to generate a new form. The new form may subsequently be delivered to remote developer 106 as form 155 via the network 112.

FIG. 3 illustrates one embodiment of a form transformation interface 300 according to the present disclosure. Form transformation interface 300 may be presented to the local developer 108, the remote developer 106, and/or the client 104 through the GUI 138, GUI 136, and/or GUI 134, respectively. At a high level, the form transformation interface 300 includes one or more selectable fields that allow a user or developer to specify, for example, a type of a desired form (e.g., purchase order, invoice) and other data that may be utilized to generate a new form through a form transformation module, such as form transformation module 130. As illustrated, form transformation interface 300 includes a form type menu 305, a form location menu 310, a form structure menu 315, and a form generator 320. Although illustrated as drop-down menus, any appropriate selection technique may be utilized. Further, more or less menus may be included as appropriate.

In some embodiments, the user or developer's selection of a type of form in the form type menu 305; a geographic location (e.g., country) in the form location menu 310; and a form structure (e.g., Adobe PDF document) in the form structure menu 315 may specify the particular form definitions and transformation rules (such as definitions 114 and rules 110) to be used by the form transformation module to generate a new form. For instance, by specifying a “purchase order,” “France,” and “Adobe” as illustrated, form definition 114 specific to purchase orders, transformation rules 110 specific to French purchase order requirements, and a form transformation module 130 specific to Adobe format may be utilized. Upon the developer's execution (by, for example, clicking the form generator 320), the specified form transformation module 130 may apply the specified transformation rules 110 to the specified form definition 114, thereby adjusting the form definitions 114 to account for French purchase order requirements. For example, the form definitions 114 for a purchase order may set the addressee information in an upper right quadrant of the form, while French postal regulations or rules may require such information to be in a lower right quadrant of the form. Application of the transformation rules 110 to the form definitions 114 by the form transformation module 130 may adjust the form definitions 114 to account for such a change in location. The adjusted form definitions 114 and specific data (e.g., specific addressee data provided by, for instance, the business application 122 and/or the client 104) may then be sent to the rendering engine 115 and a new form meeting the specified country requirements may be generated.

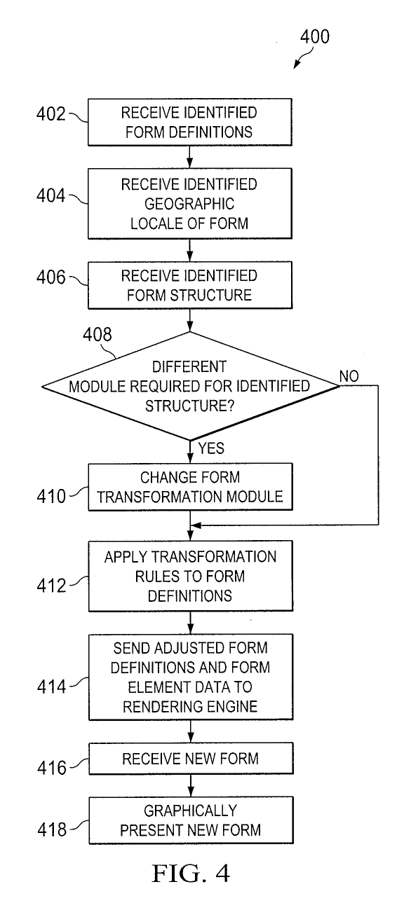

Turning now to FIG. 4, one example method 400 for using a form transformation module according to the present disclosure is illustrated. Method 400, for example, may be utilized with form transformation module 130 on system 100 shown in FIG. 1. Further, method 400 may be implemented by one or more of the local developer 108, the remote developer 106, the client 104, or other appropriate user. Method 400 may begin at 402 when the form transformation module receives one or more identified form definitions. The form definitions may be identified, for example, by a local developer through a GUI by identifying a type of form (e.g., purchase order, invoice, shipping notification). The form transformation module may then receive an identified geographic locale of the desired form at 404. For instance, identification of the geographic locale by the local developer (as well as identification of the form definitions) may also identify one or more transformation rules applicable to the form type requirements of the identified geographic locale. The form transformation module may then receive an identified form structure at 406. The form structure (e.g., Adobe PDF, Microsoft Infopad) may also be identified or selected by the local developer through the GUI.

Continuing with method 400, the form transformation module may determine at 408 whether the identified form structure requires an alternate form transformation module. For instance, the form transformation module receiving the identified data may be specific to a particular form structure, such as an Adobe PDF structure. The identified form structure received in step 406 may be a Microsoft Infopad structure (or other structure). The receiving form transformation module may therefore call or execute a separate or sub-form transformation module applicable to the identified form structure in 410. If the identified form structure does not require an alternate form transformation module in 408, then the receiving form transformation module may be utilized. In any event, the appropriate form transformation module may then apply the previously identified transformation rules to the previously identified form definitions in 412. By applying the transformation rules to the form definitions, the form transformation module may thus adjust or change the form definitions to account for the differences in a generic form of the specified type (or form specific to a different geographic locale) and a particular form specific to the identified geographic locale.

In 414, the form transformation module may send the adjusted form definitions and also form element data specific to the identified form type to a rendering engine, such as the rendering engine 115 illustrated in FIG. 1. The specific form element data may be sent or called by the form transformation module and may include data originating at or generated by a client or user. For instance, specific data for an “addressee” form element may be the specific address of the client or user. The form transformation module may then receive a new form rendered by the rendering engine according to the adjusted form definitions and specific form element data at 416. The new form (e.g., form 118 illustrated in FIG. 1) may be presented to the local developer at 418. Alternatively, in some embodiments of method 400, the new form may be stored in memory 120, transmitted to client 104, and/or called or referenced by business application 122 where appropriate.

A number of embodiments have been described. Nevertheless, it will be understood that various modifications may be made. For instance, the illustrated steps of method 400 may be performed in a different order than that shown in FIG. 4. Further, one or more of the illustrated steps of method 400 may not be performed. One or more additional steps not illustrated herein may be implemented in some embodiments of method 400. In addition, other methods related to the form transformation module according to the present disclosure may be implemented. Accordingly, other embodiments are within the scope of the following claims.

What is claimed is:

1. A computer-implemented method for generating a form, the method comprising the following steps performed by one or more processors:
identifying at least one form definition defining a form, the form comprising a form element having at least one value set by the form definition;
applying at least one rule to the form definition, the rule associated with the form element; and
adjusting, based on the rule, the value of the form element in the form definition.

2. The method of claim 1, the form comprising a first form, adjusting, based on the rule, the value of the form element in the form definition comprises adjusting, based on the rule, the value of the form element in the form definition relative to a value of a corresponding form element in a second form.

3. The method of claim 2, where adjusting, based on the rule, the value of the form element in the form definition comprises adjusting at least one of:
a location of the form element within the first form relative to a location of the corresponding form element in the second form;
a font size of the form element within the first form relative to a font size of the corresponding form element in the second form; and
a font color of the form element within the first form relative to a location of the corresponding form element in the second form.

4. The method of claim 1 further comprising sending the adjusted form definition and form element data associated with the form element to a rendering engine.

5. The method of claim 4 further comprising:
receiving a new form comprising the form element having the adjusted value and the form element data from the rendering engine; and
graphically presenting the new form to a user.

6. The method of claim 1 further comprising generating the rule based on at least one of:
a predetermined geographic locale; and
a type of the form template.

7. The method of claim 1, the rule stored in an XML document.

8. The method of claim 1, the form comprising at least one of:
a purchase order;
a delivery note;
an invoice;
a shipping notification; and
a mailing label.

9. A computer program product for generating a form, the computer program product comprising computer readable instructions embodied on tangible media that are operable when executed to:
identify at least one form definition defining a form, the form comprising a form element having at least one value set by the form definition;
apply at least one rule to the form definition, the rule associated with the form element; and
adjust, based on the rule, the value of the form element in the form definition.

10. The computer program product of claim 9, the form comprising a first form, the instructions further operable to adjust, based on the rule, the value of the form element in the form definition relative to a value of a corresponding form element in a second form.

11. The computer program product of claim 10, the instructions further operable to adjust at least one of:
a location of the form element within the first form relative to a location of the corresponding form element in the second form;
a font size of the form element within the first form relative to a font size of the corresponding form element in the second form; and
a font color of the form element within the first form relative to a location of the corresponding form element in the second form.

12. The computer program product of claim 9, the instructions further operable to send the adjusted form definition and form element data associated with the form element to a rendering engine.

13. The computer program product of claim 12, the instructions further operable to:
receive a new form comprising the form element having the adjusted value and the form element data from the rendering engine; and
graphically present the new form to a user.

14. The computer program product of claim 9, the instructions further operable to generate the rule based on at least one of:
a predetermined geographic locale; and
a type of the form template.

15. The computer program product of claim 9, the rule stored in an XML document.

16. The computer program product of claim 9, the form comprising at least one of:
a purchase order;
a delivery note;
an invoice;
a shipping notification; and
a mailing label.

17. A system for generating a form, comprising:
at least one memory storing:
at least one form transformation module;
at least one transformation rule; and
at least one form definition; and
one or more processors operable to execute the form transformation module, the module operable when executed to:
identify at least one form definition defining a form, the form comprising a form element having at least one value set by the form definition;
apply the transformation rule to the form definition, the rule associated with the form element; and
adjust, based on the rule, the value of the form element in the form definition.

18. The system of claim 17, the form comprising a first form, the form transformation module further operable to adjust, based on the rule, the value of the form element in the form definition relative to a value of a corresponding form element in a second form.

19. The system of claim 18, the form transformation module further operable to adjust at least one of:
a location of the form element within the first form relative to a location of the corresponding form element in the second form;
a font size of the form element within the first form relative to a font size of the corresponding form element in the second form; and
a font color of the form element within the first form relative to a location of the corresponding form element in the second form.

20. The system of claim 17, the system further comprising a rendering engine stored in the memory, the form transformation module further operable to:
send the adjusted form definition and form element data associated with the form element to the rendering engine;
receive a new form comprising the form element having the adjusted value and the form element data from the rendering engine; and
graphically present the new form to a user.

21. The system of claim 17, the form transformation module further operable to generate the rule based on at least one of:
a predetermined geographic locale; and
a type of the form template.

22. The system of claim 17, the form transformation module comprising a first form transformation module, the first form transformation module further operable to:
identify a first form structure of the form, the first form transformation module associated with a second form structure; and
identify, based on the first form structure, a second form transformation module associated with the first form structure, the second form transformation module operable when executed by the processor to:
identify at least one form definition defining the form, the form comprising a form element having at least one value set by the form definition;
apply the transformation rule to the form definition, the rule associated with the form element; and
adjust, based on the rule, the value of the form element in the form definition.
